(19) United States
(12) Patent Application Publication
(10) Pub. No.: US 2024/0161954 A1
(43) Pub. Date: May 16, 2024

(54) Supporting Base, a Superconducting Magnet Assembly, and a Method for Manufacturing the Supporting Base

(71) Applicant: Siemens Healthcare Limited, Camberley (GB)

(72) Inventors: Jianping He, Shenzhen (CN); Bin He, Shenzhen (CN); Kui Xiang Gu, Shenzhen (CN); Li Kai Huang, Shenzhen (CN)

(73) Assignee: Siemens Healthcare Limited, Camberley (GB)

(21) Appl. No.: 18/506,404

(22) Filed: Nov. 10, 2023

(30) Foreign Application Priority Data
Nov. 11, 2022 (CN) 202211410861.8

(51) Int. Cl. H01F 6/06

(52) U.S. Cl. CPC H01F 6/06

(57) ABSTRACT

The present disclosure provides a supporting base, a superconducting magnet assembly, and a method for manufacturing the supporting base. The supporting base comprises an annular supporting base body and a reinforcing hoop, the axes of the supporting base body and reinforcing hoop are both arranged coaxially with the axis of the inner coil, and the reinforcing hoop is sleeved and fixed on an outer surface of the supporting base body, wherein first connecting parts are provided on the reinforcing hoop, and bracket units for supporting a shield coil of a superconducting magnet can be connected to the reinforcing hoop using the first connecting parts. By means of providing the reinforcing hoop, the rigidity of the whole inner coil is increased, the thickness of the supporting base body is decreased, and material costs are reduced; the reinforcing hoop provides a connection interface for the bracket units, and the bracket units can be directly connected to the reinforcing hoop, further reducing material costs.

### CROSS-REFERENCE TO RELATED APPLICATIONS

The present application claims priority to and the benefit of China patent application no. CN 202211410861.8, filed on Nov. 11, 2022, the contents of which are incorporated herein by reference in their entirety.

### TECHNICAL FIELD

The present disclosure relates to the technical field of medical equipment, and especially to a supporting base, a superconducting magnet assembly, and a method for manufacturing the supporting base.

### BACKGROUND

A superconducting magnet refers to an electromagnet with a coil made from a type-II superconductor having a high transition temperature and an especially high critical field, used at low temperatures, and widely used in magnetic resonance imaging (MRI) systems because it has high stability and easily achieves high magnetic field strength.

In recent years, magnets that use dry cooling technology (called dry magnets) have become increasingly popular. Since these barely require liquid helium, they can significantly reduce costs. A normal magnet must be fixed on a liquid helium container; since a liquid helium container is not provided in a dry magnet, the dry magnet must be directly fixed on an outer vacuum container (OVC) surrounding the outside of the magnet. To reduce the conduction of heat from the vacuum container to the dry magnet, components connecting the dry magnet to the vacuum container must be sufficiently thin and long; for example, tension rods are used to connect the magnet to the vacuum container.

In addition, by using dry cooling technology, less copper is used on the superconducting coil, which reduces the hardness of the coil and the overall magnet. In a situation in which the hardness of the magnet is reduced, when the dry magnet is fixed to the vacuum container, a large deformation is easily produced, resulting in poor harmonic performance.

Conventionally, to increase the rigidity and hardness of a magnet, as shown in FIG. 1, multiple annular supporting bases 10′ whose axis is parallel to a coil axis are provided spaced apart from each other on the magnet, and the material of the supporting bases 10′ is fiberglass. Inner coils 20′ encircle outer spaces of adjacent supporting bases in the axial direction, bracket units 30′ are used to fix the inner coils 20′ and shield coils 50′ of superconducting magnets at design positions, and the bracket units 30′ are in bolt connection with the supporting bases 10′, thereby further increasing the rigidity of the magnet.

However, in a situation in which the above measures are used, since the material of the supporting bases is fiberglass and it is difficult to fix the bottoms of bolts to fiberglass, it is necessary to provide expensive bolt insertion members on the inside of the fiberglass, and the bolts must be twisted into the bolt insertion members to achieve fixing. This arrangement results in an increase in cost and additional steps for manufacturing the magnet.

### SUMMARY

The technical problems to be solved by the present disclosure are to provide a supporting base, a superconducting magnet assembly, and a method for manufacturing the supporting base, to overcome the defects of rigidity and strength being insufficient for conventional magnets, i.e. it being necessary to provide bolt insertion members on a supporting base of fiberglass material with higher costs.

The present disclosure solves the above-mentioned technical problems by means of the following technical solutions:

The present disclosure provides a supporting base, arranged spaced apart in the axial direction of an inner coil of a superconducting magnet, the supporting base comprising an annular supporting base body and a reinforcing hoop, the axes of the supporting base body and the reinforcing hoop both being arranged coaxially with the axis of the inner coil, and the reinforcing hoop being sleeved and fixed on an outer surface of the supporting base body, wherein a first connecting part is provided on the reinforcing hoop, and, using the first connecting part, a bracket unit for supporting a shield coil of the superconducting magnet can be connected to the reinforcing hoop.

In the present solution, by means of sleeving the reinforcing hoop on the outside of the supporting base body, the rigidity of the whole inner coil is increased, and it is not necessary to use a thicker supporting base body, thereby reducing material costs of the supporting base body. The structure of the reinforcing hoop is simple, it is easy to manufacture, and assembly is convenient. The reinforcing hoop can also provide a connection interface for the bracket unit, i.e. it is not necessary to connect the bracket unit to the supporting base body of fiberglass material, and thereby is not necessary to provide an expensive bolt insertion member on the supporting base body. The bracket unit can be directly connected to the reinforcing hoop, further reducing material costs.

In an embodiment, the supporting base further comprises at least one ring-shaped limiting member, the limiting member is arranged on an outer surface of the supporting base body, and is clamped to an end face, in the axial direction, of the reinforcing hoop.

In the present embodiment, the limiting member is used for limiting the reinforcing hoop, bearing a shearing force, preventing the reinforcing hoop from being displaced in the axial direction such that the overall structure of the supporting base is more stable.

In an embodiment, multiple layers of glass cloth are wound on at least one side of the reinforcing hoop around the supporting base and, after the supporting base is potted using a resin material, the glass cloth forms fiberglass to act as the limiting member.

In the present embodiment, one aspect comprises using the property by which glass cloth can become fiberglass material after potting with resin enables the limiting member to better bear a shearing force and improves the bonding performance of the limiting member on the supporting base body. In another aspect, during potting, resin can enter a gap between the reinforcing hoop and the supporting base or limiting member, causing the reinforcing hoop to fully bond to the supporting base body.

In an embodiment, the supporting base body comprises a first segment having a first outer diameter and a second segment having a second outer diameter, and the first outer diameter is greater than the second outer diameter so that the supporting base body forms a stepped shape, the reinforcing hoop is sleeved on an outer surface of the second segment, and a first end face, in the axial direction, of the reinforcing hoop is clamped to a side face, of the first segment, near the second segment.

In the present embodiment, by means of configuring the supporting base body as a stepped shape, one end of the reinforcing hoop can be clamped to the supporting base body, thereby bearing a shearing force coming from the axial direction.

In an embodiment, the supporting base further comprises a ring-shaped limiting member, the limiting member is arranged on an outer surface of the supporting base body, and is clamped to a second end face, in the axial direction, of the reinforcing hoop.

In the present embodiment, one end of the reinforcing hoop is clamped to the stepped structure of the supporting base body, and the other end is clamped to the limiting member, making it possible to limit the reinforcing hoop in the overall axial direction and bear a shearing force in the axial direction, preventing the reinforcing hoop from being displaced in the axial direction.

In an embodiment, the reinforcing hoop is in bolt connection with or bonded to the supporting base body.

In the present embodiment, the reinforcing hoop is connected to the supporting base body in advance by means of a bolt, realizing a function of preliminarily fixing the reinforcing hoop. The reinforcing hoop may also be bonded to the supporting base body in advance to preliminarily fix the reinforcing hoop to the supporting base body.

In an embodiment, multiple said first connecting parts are arranged spaced apart from each other along the circumference of the reinforcing hoop, first threaded holes are provided on the first connecting parts, and the reinforcing hoop is in threaded connection with the bracket unit.

In the present solution, threaded holes are arranged on the reinforcing hoop, providing a connection interface for the supporting base and bracket units, the bracket units may be fixed to the reinforcing hoop using bolts, and the bracket units are detachably connected to the supporting base simply and conveniently.

In an embodiment, multiple second connecting parts spaced apart from each other are provided along the circumference of the reinforcing hoop, and tension rods can be connected to the supporting base by means of the second connecting parts.

In the present embodiment, the space on the reinforcing hoop is fully utilized, providing a connection interface for the supporting base and the tension rods. It is not necessary to provide an additional connection point on the supporting base, and the tension rods are connected to the supporting base simply and conveniently.

In an embodiment, the second connecting parts are block-shaped structures, and extend radially out from the outer surface of the reinforcing hoop, and the second connecting parts are provided with second threaded holes.

In the present embodiment, by means of configuring the second connecting parts to protrude beyond the outer surface of the reinforcing hoop, the tension rods can pass into the second connecting parts at various angles, facilitating threaded connection of the tension rods to the second connecting parts.

In an embodiment, the material of the reinforcing hoop is stainless steel.

In the present embodiment, the rigidity of stainless steel is about 16 times that of fiberglass material, so the use of stainless steel material to make the reinforcing hoop can maximally increase the structural rigidity of the supporting base.

The present embodiment further provides a superconducting magnet assembly comprising an inner coil, a shield coil, a bracket unit, and the above-referenced supporting base, wherein multiple said supporting bases are arranged spaced apart from each other in the axial direction on the inner coil, and two ends of the bracket unit are respectively connected to the reinforcing hoop and the shield coil, to hold the shield coil on the outside of the inner coil.

In the present embodiment, after the supporting bases are employed on the superconducting magnet assembly, correspondingly, the structural rigidity is stronger, material costs are saved, assembly is convenient, and it is not necessary to connect the bracket units to the supporting base body of fiberglass material. The bracket units can be directly connected to the reinforcing hoop, further reducing material costs.

In an embodiment, multiple first connecting parts spaced apart from each other are provided on the reinforcing hoop, first threaded holes are provided on the first connecting parts, bottoms of the bracket units are provided with connecting faces, the connecting faces abut outer surfaces of the first connecting parts, and are in a threaded connection with the first connecting parts by means of the first threaded holes.

In an embodiment, multiple second connecting parts spaced apart from each other are provided on the reinforcing hoop, the second connecting parts are block-shaped structures, and extend radially out from the outer surface of the reinforcing hoop, and the second connecting parts are provided with second threaded holes; the superconducting magnet assembly further comprises tension rods, one end of the tension rod passes into and is in threaded connection with the second connecting part, and the other end of the tension rod is connected to an external structure of the superconducting magnet assembly.

In the present embodiment, the tension rods are used for fixing the inner coils to a vacuum container or another external structure of the superconducting magnet assembly. The tension rods are slender rod-shaped structures and can reduce conduction of heat from the vacuum container to the inner coils.

The present embodiment further provides a method for manufacturing a supporting base, the method being used for manufacturing the supporting base described above, and the manufacturing method comprises:
S1: sleeve and fix the reinforcing hoop on an outer surface of the supporting base body;
S2: wind multiple layers of glass cloth on at least one side of the reinforcing hoop around the supporting base; and
S3: pot the supporting base using a resin material to cause the glass cloth to form fiberglass.

In the present embodiment, using the property by which glass cloth can become fiberglass material after potting with resin, the glass cloth is better able to bear a shearing force after becoming fiberglass, and the bonding performance of the fiberglass on the supporting base body is improved. In another aspect, during potting, resin can enter a gap between the reinforcing hoop and the supporting base, causing the reinforcing hoop to fully bond to the supporting base body.

In an embodiment, the supporting base body comprises a first segment having a first outer diameter and a second segment having a second outer diameter, and the first outer diameter is greater than the second outer diameter, so that the supporting base body forms a stepped shape, wherein step S1 comprises:
S11: sleeve and fix the reinforcing hoop on an outer surface of the second segment, and clamp a first end face, in the axial direction, of the reinforcing hoop to a side face, of the first segment, near the second segment.

In the present embodiment, by means of configuring the supporting base body as a stepped shape, a first end face of the reinforcing hoop can be clamped to the supporting base body, thereby bearing a shearing force coming from the axial direction.

In an embodiment, step S2 comprises:
S21: wind multiple layers of glass cloth on one side, of the reinforcing hoop, remote from the first segment around the supporting base.

In the present embodiment, one end of the reinforcing hoop is clamped to the stepped structure of the supporting base body, and the other end is clamped to fiberglass, making it possible to limit the reinforcing hoop in the overall axial direction, and bear a shearing force in the axial direction, preventing the reinforcing hoop from being displaced in the axial direction.

Positive progressive effects of the present disclosure lie in: regarding the supporting base, by means of sleeving the reinforcing hoop on the outside of the supporting base body, the rigidity of the whole inner coil is increased, and it is not necessary to use a thicker supporting base body, reducing material costs of the supporting base body; the structure of the reinforcing hoop is simple, it is easy to manufacture, and assembly is convenient; the reinforcing hoop can also provide a connection interface for bracket units, it is not necessary to connect the bracket units to the supporting base body of fiberglass material, and thereby is not necessary to provide expensive bolt insertion members on the supporting base body; the bracket units can be directly connected to the reinforcing hoop, further reducing material costs. Regarding the superconducting magnet assembly, the structural rigidity is stronger, material costs are saved, assembly is convenient, and it is not necessary to connect the bracket units to the supporting base body of fiberglass material; the bracket units can be directly connected to the reinforcing hoop, further reducing material costs. Regarding the manufacturing method for the supporting base, using the property by which glass cloth can become fiberglass material after potting with resin, the glass cloth is better able to bear a shearing force after becoming fiberglass, and the bonding performance of the fiberglass on the supporting base body is improved; in another aspect, during potting, resin can enter a gap between the reinforcing hoop and the supporting base, causing the reinforcing hoop to fully bond to the supporting base body.

### BRIEF DESCRIPTION OF THE DRAWINGS

Embodiments of the present disclosure are described in detail below with reference to the accompanying drawings, to give those skilled in the art a clearer understanding of the abovementioned and other features and advantages of the present disclosure.

FIG. 1 illustrates a conventional schematic structural diagram of a superconducting magnet assembly;

FIG. 2 illustrates a schematic structural diagram of a superconducting magnet assembly according to an embodiment of the present disclosure;

FIG. 3 illustrates a three-dimensional schematic structural diagram of inner coils and supporting bases according to an embodiment of the present disclosure.

FIG. 4 illustrates a three-dimensional schematic structural diagram of a reinforcing hoop according to an embodiment of the present disclosure.

FIG. 5 illustrates a schematic structural diagram of a supporting base according to an embodiment of the present disclosure.

FIG. 6 illustrates a three-dimensional schematic structural diagram of a superconducting magnet assembly according to an embodiment of the present disclosure, wherein shield coils are not shown.

FIG. 7 illustrates a three-dimensional schematic structural diagram of a superconducting magnet assembly according to an embodiment of the present disclosure.

FIG. 8 illustrates a partial schematic structural diagram of a superconducting magnet assembly according to an embodiment of the present disclosure.

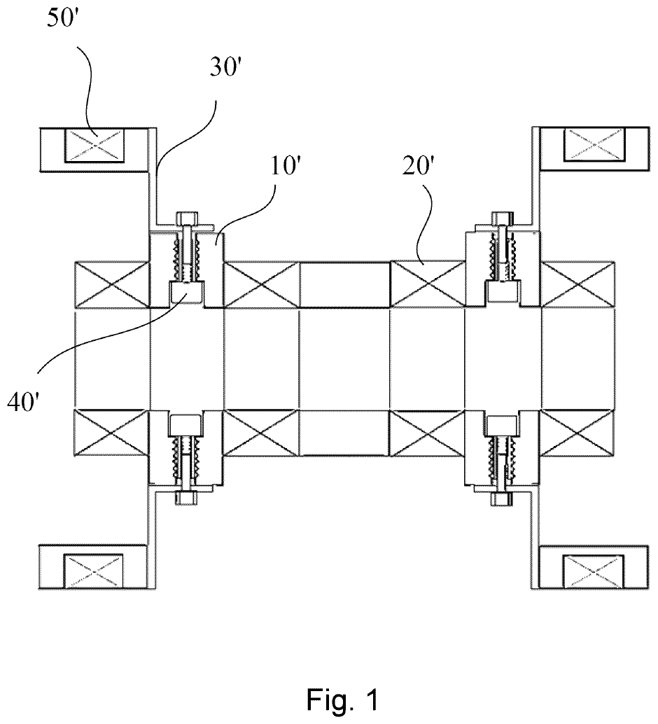

In Background Art, the reference labels are as follows:
Supporting base 10′
Inner coil 20′
Bracket unit 30′
Bolt insertion member 40′
Shield coil 50′
In Detailed Description of Embodiments, the reference labels are as follows:
Supporting base 10
Supporting base body 101
Reinforcing hoop 102
First connecting part 1021
First threaded hole 1022
Second connecting part 1023
Second threaded hole 1024
Limiting member 103
First segment 104
Second segment 105
Inner coil 20
Bracket unit 30
Tension rod 40
Shield coil 50
Superconducting magnet assembly 100

### DETAILED DESCRIPTION OF THE DISCLOSURE

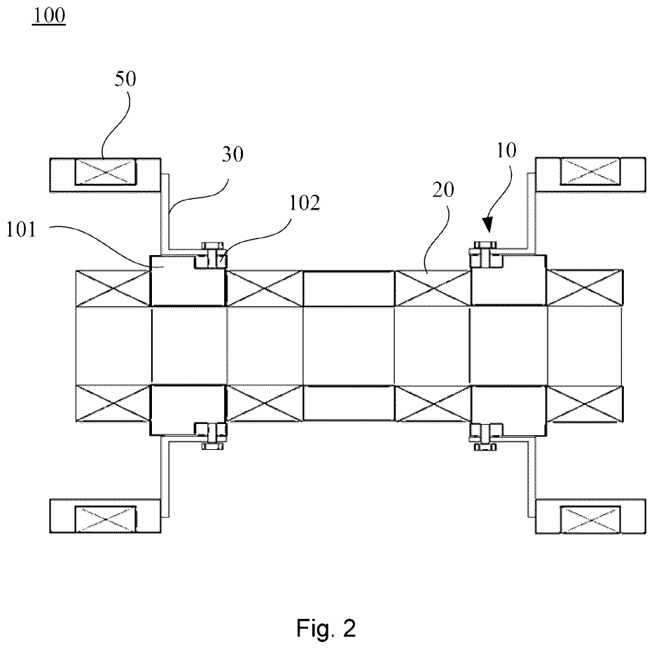

To enable a clearer understanding of the technical features, objectives, and effects of the present disclosure, particular embodiments of the present disclosure are now explained with reference to the accompanying drawings, in which identical labels indicate identical parts. The present embodiment presents a supporting base 10, arranged spaced apart along the axial direction of an inner coil 20 of a superconducting magnet. As shown in FIGS. 2-8, the supporting base 10 comprises an annular supporting base body 101 and a reinforcing hoop 102, the axes of the supporting base body 101 and reinforcing hoop 102 are both arranged coaxially with the axis of the inner coil 20, and the reinforcing hoop 102 is sleeved and fixed on an outer surface of the supporting base body 101.

First connecting parts 1021 are provided on the reinforcing hoop 102, and, using the first connecting parts 1021, bracket units 30 for supporting a shield coil 50 of a superconducting magnet can be connected to the reinforcing hoop 102 by means of the first connecting parts 1021.

In the present embodiment, by means of sleeving the reinforcing hoop 102 on the outside of the supporting base body 101, the rigidity of the whole inner coil 20 is increased, and it is not necessary to use a thicker supporting base body 101, thereby reducing material costs of the supporting base body 101. The structure of the reinforcing hoop 102 is simple, it is easy to manufacture, and assembly is convenient. The reinforcing hoop 102 can also provide a connection interface for the bracket units 30, and it is not necessary to connect the bracket units 30 to the supporting base body 101 of fiberglass material, and thereby is not necessary to provide expensive bolt insertion members on the supporting base body 101. The bracket units can be directly connected to the reinforcing hoop 102, further reducing material costs.

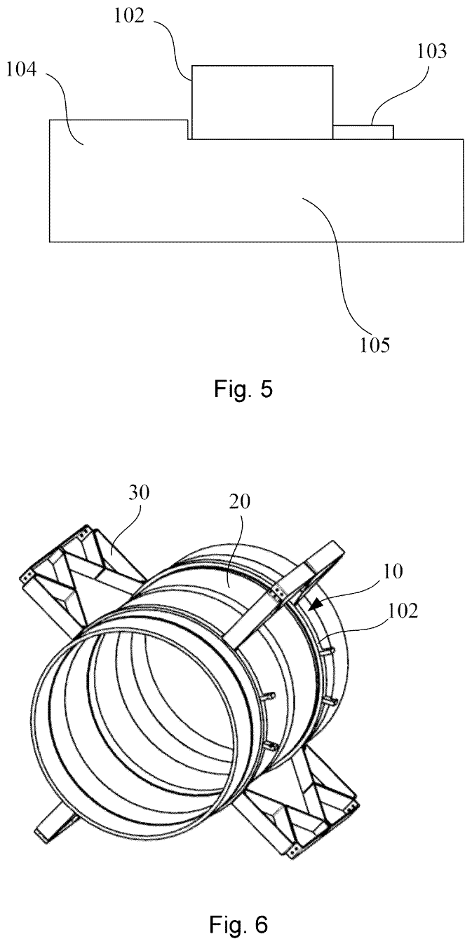

As shown in FIG. 5, the supporting base 10 further comprises at least one ring-shaped limiting member 103, the limiting member 103 is arranged on an outer surface of the supporting base body 101, and is clamped to an end face, in the axial direction, of the reinforcing hoop 102. The limiting member 103 is used for limiting the reinforcing hoop 102, bearing a shearing force, preventing the reinforcing hoop 102 from being displaced in the axial direction, such that the overall structure of the supporting base 10 is more stable. Multiple layers of glass cloth are wound on at least one side of the reinforcing hoop 102 around the supporting base 10 and, after the supporting base 10 is potted using a resin material, the glass cloth forms fiberglass to act as the limiting member 103. In one aspect, using the property by which glass cloth can become fiberglass material after potting with resin enables the limiting member 103 to better bear a shearing force, and improves the bonding performance of the limiting member 103 on the supporting base body 101. In another aspect, during potting, resin can enter a gap between the reinforcing hoop 102 and the supporting base 10 or limiting member 103, causing the reinforcing hoop 102 to fully bond to the supporting base body 101.

As shown in FIG. 5, the supporting base body 101 comprises a first segment 104 having a first outer diameter and a second segment 105 having a second outer diameter, the first outer diameter is greater than the second outer diameter, so that the supporting base body 101 forms a stepped shape, the reinforcing hoop 102 is sleeved on an outer surface of the second segment 105, and a first end face, in the axial direction, of the reinforcing hoop 102 is clamped to a side face, of the first segment 104, near the second segment 105. By means of configuring the supporting base body 101 as a stepped shape, one end of the reinforcing hoop 102 can be clamped to the supporting base body 101, thereby bearing a shearing force coming from the axial direction.

The supporting base 10 further comprises a ring-shaped limiting member 103, the limiting member 103 is arranged on an outer surface of the supporting base body 101, and is clamped to a second end face, in the axial direction, of the reinforcing hoop 102. One end of the reinforcing hoop 102 is clamped to the stepped structure of the supporting base body 101, and the other end is clamped to the limiting member 103, making it possible to limit the reinforcing hoop 102 in the overall axial direction, and bear a shearing force in the axial direction, thus preventing the reinforcing hoop 102 from being displaced in the axial direction.

It should be noted that, in the present embodiment, one side of the reinforcing hoop 102 is clamped to the stepped structure and the other side is clamped to the limiting member 103, so as to limit the reinforcing hoop 102. The means for limiting the reinforcing hoop 102 are not limited to this. In another alternative embodiment, it is also possible that limiting members 103 are respectively arranged at two sides of the reinforcing hoop 102, after the reinforcing hoop 102 is sleeved on the supporting base body 101, i.e. multiple layers of glass cloth are respectively wound on two sides of the reinforcing hoop and, after potting with a resin material, form fiberglass to realize a limiting effect.

Specifically, the reinforcing hoop 102 is in a bolt connection with or bonded to the supporting base body 101. The reinforcing hoop 102 is connected to the supporting base body 101 in advance by means of a bolt, realizing a function of preliminarily fixing the reinforcing hoop 102. The reinforcing hoop 102 may also be bonded to the supporting base body 101 in advance, to preliminarily fix the reinforcing hoop 102 to the supporting base body 101.

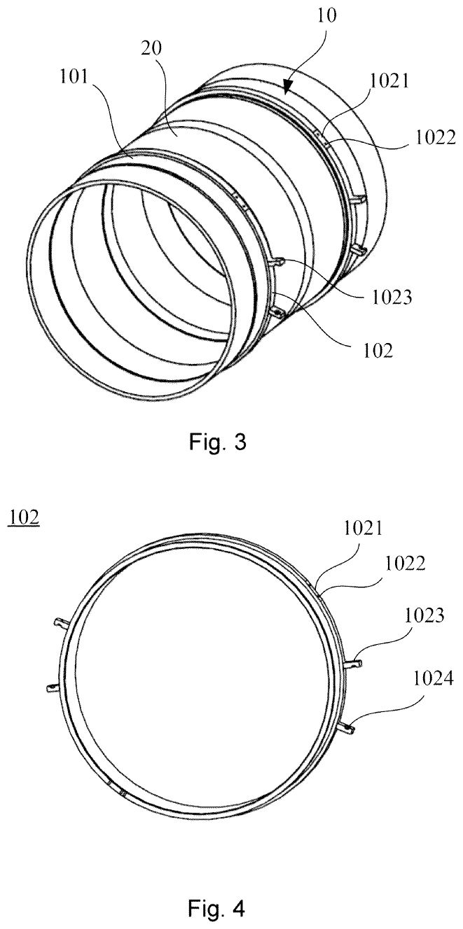

As shown in FIGS. 3-4, multiple first connecting parts 1021 are arranged spaced apart from each other along the circumference of the reinforcing hoop 102, first threaded holes 1022 are provided on the first connecting parts 1021, and the reinforcing hoop 102 is in threaded connection with the bracket units 30. Threaded holes are provided on the reinforcing hoop 102, providing a connection interface for the supporting base 10 and the bracket units 30. The bracket units 30 may be fixed to the reinforcing hoop 102 using bolts, and the bracket units 30 are detachably connected to the supporting base 10 simply and conveniently.

As shown in FIGS. 3-4, multiple second connecting parts 1023 spaced apart from each other are provided along the circumference of the reinforcing hoop 102, and tension rods 40 are connected to the supporting base 10 by means of the second connecting parts 1023. The space on the reinforcing hoop 102 is fully utilized, providing a connection interface for the supporting base 10 and the tension rods 40. It is not necessary to additionally arrange a connection point on the supporting base 10, and the tension rods 40 are connected to the supporting base 10 simply and conveniently.

The second connecting parts 1023 are block-shaped structures and extend radially out from the outer surface of the reinforcing hoop 102, and the second connecting parts 1023 are provided with second threaded holes 1024. By means of configuring the second connecting parts 1023 to protrude beyond the outer surface of the reinforcing hoop 102, the tension rods 40 can pass into the second connecting parts 1023 at various angles, facilitating threaded connection of the tension rods 40 with the second connecting parts 1023.

The material of the reinforcing hoop 102 is stainless steel. The rigidity of stainless steel is about 16 times that of fiberglass material, so the use of stainless steel material to make the reinforcing hoop 102 can maximally increase the structural rigidity of the supporting base 10. It should be noted that the material of the reinforcing hoop 102 is not limited to stainless steel, and other metal materials, such as an aluminum alloy, may also be used, as long as a threaded hole can be provided therein.

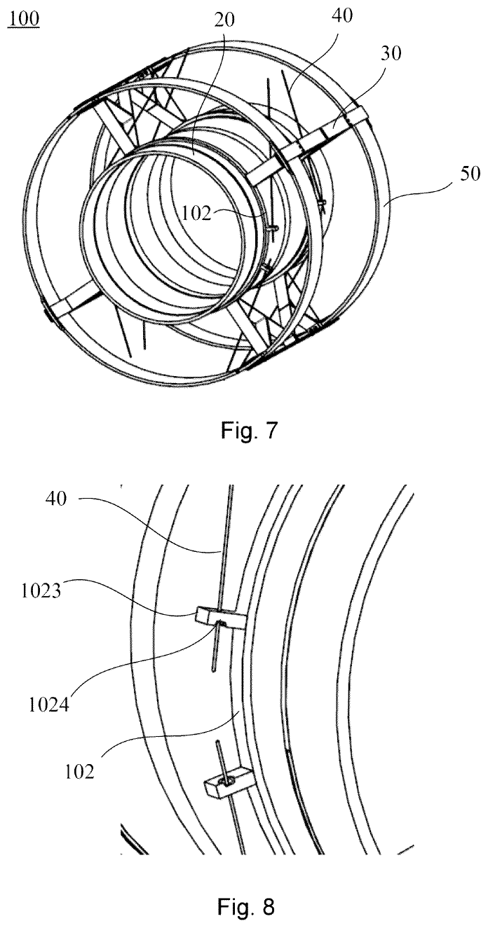

As shown in FIGS. 7-8, the present disclosure further provides a superconducting magnet assembly 100, comprising inner coils 20, shield coils 50, bracket units 30, and the above-mentioned supporting base 10, wherein multiple supporting bases 10 are arranged spaced apart from each other in the axial direction on the inner coils 20, and two ends of the bracket unit 30 are respectively connected to the reinforcing hoop 102 and the shield coil 50, to hold the shield coils 50 on the outside of the inner coils 20.

In the present embodiment, after the supporting bases 10 are employed on the superconducting magnet assembly 100, correspondingly, the structural rigidity is stronger, material costs are saved, assembly is convenient, and it is not necessary to connect the bracket units 30 to the supporting base bodies 101 of fiberglass material. The bracket units can be directly connected to the reinforcing hoop 102, further reducing material costs.

Multiple first connecting parts 1021 spaced apart from each other are provided on the reinforcing hoop 102, first threaded holes 1022 are provided on the first connecting parts 1021, bottoms of the bracket units 30 are provided with connecting faces, and the connecting faces abut outer surfaces of the first connecting parts 1021, and are in threaded connection with the first connecting parts 1021 by means of the first threaded holes 1022.

Multiple second connecting parts 1023 spaced apart from each other are provided on the reinforcing hoop 102, the second connecting parts 1023 are block-shaped structures, and extend radially out from the outer surface of the reinforcing hoop 102, and the second connecting parts 1023 are provided with second threaded holes 1024.

The superconducting magnet assembly 100 further comprises tension rods 40, one end of the tension rod 40 passes into and is in threaded connection with the second connecting part 1023, and the other end of the tension rod 40 is connected to an external structure of the superconducting magnet assembly 100. The tension rods 40 are used for fixing the inner coil 20 to a vacuum container or another external structure of the superconducting magnet assembly 100. The tension rods 40 are slender rod-shaped structures, and can reduce conduction of heat from the vacuum container to the inner coil 20.

The present embodiments further present a method for manufacturing a supporting base 10, the method being used for manufacturing the supporting base 10 described above, and the manufacturing method comprises:
S1: sleeve and fix a reinforcing hoop 102 on an outer surface of a supporting base body 101;
S2: wind multiple layers of glass cloth on at least one side of the reinforcing hoop 102 around the supporting base 10; and
S3: pot the supporting base 10 using a resin material to cause the glass cloth to form fiberglass.

In the present embodiment, using the property by which glass cloth can become fiberglass material after potting with resin, the glass cloth is better able to bear a shearing force after becoming fiberglass, and the bonding performance of the fiberglass on the supporting base body 101 is improved. Additionally or alternatively, during potting, resin can enter a gap between the reinforcing hoop 102 and the supporting base 10, causing the reinforcing hoop 102 to fully bond to the supporting base body 101.

The supporting base body 101 comprises a first segment 104 having a first outer diameter and a second segment 105 having a second outer diameter, and the first outer diameter is greater than the second outer diameter, so that the supporting base body 101 forms a stepped shape, wherein step S1 comprises:

S11: sleeve and fix the reinforcing hoop 102 on an outer surface of the second segment 105, and clamp a first end face, in the axial direction, of the reinforcing hoop 102 to a side face, of the first segment 104, near the second segment 105.

By means of configuring the supporting base body 101 as a stepped shape, a first end face of the reinforcing hoop 102 can be clamped to the supporting base body 101, thereby bearing a shearing force coming from the axial direction.

Step S2 comprises:
S21: wind multiple layers of glass cloth on one side, of the reinforcing hoop 102, remote from the first segment 104 around the supporting base 10.

One end of the reinforcing hoop 102 is clamped to the stepped structure of the supporting base body 101, and the other end is clamped to the fiberglass, making it possible to limit the reinforcing hoop 102 in the overall axial direction, and bear a shearing force in the axial direction, preventing the reinforcing hoop 102 from being displaced in the axial direction.

It should be understood that although the present description is based on various embodiments, it is by no means the case that each embodiment contains just one independent technical solution. Such a method of presentation is adopted in the description purely for the sake of clarity. Those skilled in the art should consider the description in its entirety. The technical solutions in the various embodiments could also be suitably combined to form other embodiments understandable to those skilled in the art.

The series of detailed explanations set out above are merely particular explanations of feasible embodiments of the present disclosure, and are not intended to limit the scope of protection thereof. All equivalent embodiments or changes made without departing from the artistic spirit of the present disclosure, such as combinations, divisions or repetitions of features, shall be included in the scope of protection of the present disclosure.

What is claimed is:

1. A supporting base arranged spaced apart in an axial direction of an inner coil of a superconducting magnet, the supporting base comprising:
an annular supporting base body;
a reinforcing hoop that is sleeved and fixed on an outer surface of the annular supporting base body,
wherein axes of the annular supporting base body and the reinforcing hoop are each arranged coaxially with an axis of the inner coil;
a first connecting part disposed on the reinforcing hoop; and
a bracket assembly configured to support a shield coil of the superconducting magnet,
wherein the bracket assembly is configured to be coupled to the reinforcing hoop via the first connecting part.

2. The supporting base as claimed in claim 1, further comprising:
a ring-shaped limiting member arranged on the outer surface of the annular supporting base body,
wherein the ring-shaped limiting member is clamped to an end face, in the axial direction, of the reinforcing hoop.

3. The supporting base as claimed in claim 2, wherein multiple layers of glass cloth are wound on at least one side of the reinforcing hoop around the supporting base, and
wherein after the supporting base is potted using a resin material, the glass cloth forms fiberglass to act as the ring-shaped limiting member.

4. The supporting base as claimed in claim 1, wherein the annular supporting base body further comprises:
a first segment having a first outer diameter; and
a second segment having a second outer diameter,
wherein the first outer diameter is greater than the second outer diameter such that the annular supporting base body forms a stepped shape,
wherein the reinforcing hoop is sleeved on an outer surface of the second segment, and
wherein a first end face, in the axial direction, of the reinforcing hoop is clamped to a side face of the first segment proximate to the second segment.

5. The supporting base as claimed in claim 4, wherein the supporting base further comprises:
a ring-shaped limiting member, and
wherein the limiting member is arranged on the outer surface of the annular supporting base body and is clamped to a second end face, in the axial direction, of the reinforcing hoop.

6. The supporting base as claimed in claim 1, wherein the reinforcing hoop is in a bolt connection with or bonded to the annular supporting base body.

7. The supporting base as claimed in claim 1, wherein:
the first connecting part is from among a plurality of first connecting parts, each one of the plurality of first connecting parts being spaced apart from one another along a circumference of the reinforcing hoop,
each one of the plurality of first connecting parts comprises first threaded holes, and
the reinforcing hoop is in a threaded connection with the bracket assembly.

8. The supporting base as claimed in claim 1, further comprising:
a plurality of second connecting parts spaced apart from one another along a circumference of the reinforcing hoop; and
a plurality of tension rods configured to be coupled to the supporting base via the plurality of second connecting parts.

9. The supporting base as claimed in claim 8, wherein the plurality of second connecting parts are block-shaped structures and extend radially out from an outer surface of the reinforcing hoop, and
wherein the plurality of second connecting parts comprise respective second threaded holes.

10. The supporting base as claimed in claim 1, wherein the reinforcing hoop comprises a stainless steel material.

11. A superconducting magnet assembly including a superconducting magnet, the superconducting magnet assembly comprising:
an inner coil;
a shield coil;
a plurality of bracket assemblies configured to support a shield coil of the superconducting magnet; and
a plurality of supporting bases, each one of the plurality of supporting bases comprising:
an annular supporting base body;
a reinforcing hoop that is sleeved and fixed on an outer surface of the annular supporting base body,
wherein axes of the annular supporting base body and the reinforcing hoop are each arranged coaxially with an axis of the inner coil; and
a first connecting part disposed on the reinforcing hoop,
wherein each one of the plurality of bracket assemblies is configured to be coupled to the reinforcing hoop via a respective first connecting part of the plurality of supporting bases,
wherein the plurality of supporting bases are spaced apart from one another in an axial direction on the inner coil, and
wherein each one of the plurality of bracket assemblies comprises a first end connected to the reinforcing hoop and a second end connected to the shield coil to retain the shield coil on an outside of the inner coil.

12. The superconducting magnet assembly as claimed in claim 11, wherein the first connecting parts identified with the plurality of supporting bases (i) are spaced apart from one another on a respective reinforcing hoop, and (ii) comprise respective first threaded holes,
wherein a bottom of each one of the plurality of bracket assemblies comprises respective connecting faces, and
wherein the connecting faces of each one of the plurality of bracket assemblies abut outer surfaces of the first connecting parts and are in a threaded connection with the first connecting parts via the respective first threaded holes.

13. The superconducting magnet assembly as claimed in claim 11, further comprising:
a plurality of second connecting parts spaced apart from one another on each respective reinforcing hoop of the plurality of bracket assemblies, the plurality of second connecting parts (i) comprising block-shaped structures extending radially out from an outer surface of the reinforcing hoop, and (ii) comprising second threaded holes; and
a plurality of tension rods, a first end of each one of the plurality of tension rods passing into and being in a threaded connection with a respective one of the plurality of the second connecting parts, and a second of each one of the plurality of tension rods being connected to an external structure of the superconducting magnet assembly.

14. A method for manufacturing a supporting base arranged spaced apart in an axial direction of an inner coil of a superconducting magnet, the supporting base comprising (i) an annular supporting base body and a reinforcing hoop, axes of the supporting base body and the reinforcing hoop being each arranged coaxially with an axis of the inner coil, (ii) a first connecting part disposed on the reinforcing hoop, and (iii) a bracket assembly configured to support a shield coil of the superconducting magnet, wherein the bracket assembly is configured to be coupled to the reinforcing hoop via the first connecting part, the method comprising:
sleeving and fixing the reinforcing hoop on an outer surface of the annular supporting base body;
winding multiple layers of glass cloth on at least one side of the reinforcing hoop around the supporting base,
clamping the glass cloth to an end face, in the axial direction, of the reinforcing hoop; and
potting the supporting base using a resin material to cause the glass cloth to form fiberglass.

15. The method for manufacturing the supporting base as claimed in claim 14, wherein the annular supporting base body comprises a first segment having a first outer diameter and a second segment having a second outer diameter, the first outer diameter being greater than the second outer diameter such that the annular supporting base body forms a stepped shape, and
wherein the sleeving and fixing the reinforcing hoop on the outer surface of the supporting base body comprises:
sleeving and fixing the reinforcing hoop on the outer surface of the second segment; and
clamping a first end face, in the axial direction, of the reinforcing hoop to a side face of the first segment proximate to the second segment.

16. The method for manufacturing the supporting base as claimed in claim 15, wherein the winding multiple layers of the glass cloth on at least one side of the reinforcing hoop around the supporting base comprises:
winding multiple layers of glass cloth on one side of the reinforcing hoop remote from the first segment around the supporting base.
